(19) United States
(12) Patent Application Publication
(10) Pub. No.: US 2026/0186203 A1
(43) Pub. Date: Jul. 2, 2026

(54) OPTICAL WAVEGUIDE AND METHOD OF MANUFACTURING THE OPTICAL WAVEGUIDE

(71) Applicant: SAMSUNG ELECTRONICS CO., LTD., Suwon-si (KR)

(72) Inventors: Dongsik SHIM, Suwon-si (KR); Bongyong Jang, Suwon-si (KR); Woosung Kim, Suwon-si (KR); Changgyun Shin, Suwon-si (KR)

(73) Assignee: SAMSUNG ELECTRONICS CO., LTD., Suwon-si (KR)

(21) Appl. No.: 19/421,241

(22) Filed: Dec. 16, 2025

(30) Foreign Application Priority Data
Dec. 31, 2024 (KR) 10-2024-0202732

(51) Int. Cl. G02B 6/122; G02B 6/12; G02B 6/136

(52) U.S. Cl. CPC G02B 6/1223; G02B 6/136; G02B 2006/12061; G02B 2006/121; G02B 2006/12126; G02B 2006/12138; G02B 2006/1218

(57) ABSTRACT

Provided is an optical waveguide including a first face, a second face connected to the first face, and a third face connected to the second face, a level of the third face being different from a level of the first face in a first direction, and the third face being an uppermost face in the first direction, wherein a surface roughness of the first face the same as a surface roughness of the second face.

### CROSS-REFERENCE TO RELATED APPLICATION

This application is based on and claims priority under 35 U.S.C. § 119 to Korean Patent Application No. 10-2024-0202732, filed on Dec. 31, 2024, in the Korean Intellectual Property Office, the disclosure of which is incorporated by reference herein in its entirety.

### BACKGROUND

### 1. Field

The disclosure relates to an optical waveguide and a method of manufacturing the optical waveguide.

### 2. Description of Related Art

Silicon photonics devices capable of being implemented using semiconductor complementary metal-oxide semiconductor (CMOS) processes are expanding their applications to various fields such as optical sensors, optical links, optical computing, and optical memory by utilizing characteristics such as light transmission, branching, amplification, and modulation.

Silicon optical waveguides which are mainly used in photonics devices perform etching use plasma. Etched faces of optical waveguides have increased surface roughness, and as a result, light passing through optical waveguides is scattered, which causes increased light loss. Accordingly, there is a need for a method of reducing surface roughness of optical waveguides.

### SUMMARY

Provided are an optical waveguide with reduced surface roughness and a method of manufacturing the optical waveguide.

Additional aspects will be set forth in part in the description which follows and, in part, will be apparent from the description, or may be learned by practice of the presented embodiments of the disclosure.

According to an aspect of one or more embodiments, there is provided an optical waveguide including a first face, a second face connected to the first face, and a third face connected to the second face, a level of the third face being different from a level of the first face in a first direction, and the third face being an uppermost face in the first direction, wherein a surface roughness of the first face is the same as a surface roughness of the second face.

The second face may have a curved shape.

The third face may include a groove.

A depth of the groove in the first direction may be in a range of 1 nm to 100 nm.

A depth of the groove in the first direction may be in a range of 3 nm to 15 nm.

The groove may have a curved shape.

The optical waveguide may include silicon.

The optical waveguide may include a lip-type optical waveguide.

According to another aspect of one or more embodiments, there is provided a method of manufacturing an optical waveguide, the method including forming a diffusion barrier layer on the optical waveguide, forming a first face, a second face and a third face, included in the optical waveguide, by oxidizing the optical waveguide, and removing the diffusion barrier layer, wherein the second face is connected to the first face, the third face is connected to the second face, a level of the third face being different from a level of the first face in a first direction, and the third face being an uppermost face in the first direction.

A surface roughness of the first face may be the same as a surface roughness of the second face.

The diffusion barrier layer may include silicon nitride.

The method may further include etching a part of the optical waveguide and a part of the diffusion barrier layer prior to the oxidizing of the optical waveguide.

The etching may include a dry etching process.

The method may further include forming a groove in the third face.

A depth of the groove in the first direction may be in a range of 1 nm to 100 nm.

A depth of the groove in the first direction may be in a range of 3 nm to 15 nm.

The groove may have a curved shape.

The second face may have a curved shape.

According to yet another aspect of one or more embodiments, there is provided an optical integrated circuit including a light source, an optical waveguide configured to transmit light from the light source, and a photodetector configured to convert light transmitted through the optical waveguide into an electrical signal, wherein the optical waveguide includes a first face, a second face connected to the first face, and a third face connected to the second face, a level of the third face being different from a level of the first face in a first direction, and the third face being an uppermost face in the first direction, wherein a surface roughness of the first face is the same as a surface roughness of the second face.

The second face may have a curved shape.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view illustrating an optical waveguide according to one or more embodiments;

FIG. 2 is a cross-sectional view illustrating an optical waveguide according to one or more embodiments;

FIG. 3 is a scanning electron microscope image of an optical waveguide according to one or more embodiments;

FIGS. 4A, 4B, and 4C are views illustrating a method of manufacturing an optical waveguide according to one or more embodiments;

FIGS. 5A, 5B, 5C, and 5D are views illustrating a method of manufacturing an optical waveguide, according to one or more embodiments;

FIGS. 6A, 6B, and 6C are views illustrating a method of manufacturing an optical waveguide, according to one or more embodiments;

FIGS. 7A and 7B are scanning electron microscope images of an optical waveguide according to one or more embodiments;

FIG. 8 is a view illustrating a light detection and ranging (LiDAR) device according to one or more embodiments;

FIG. 9 is a block diagram of an electronic device including a LiDAR device according to one or more embodiments;

FIGS. 10 and 11 are a side view and a plan view illustrating an example in which a LiDAR device according to one or more embodiments is applied to a vehicle; and

FIG. 12 is a block diagram illustrating a configuration of an optical integrated circuit according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, an optical waveguide and a method of manufacturing the optical waveguide according to various embodiments are described in detail with reference to the accompanying drawings. Like reference numerals refer to like elements throughout, and in the drawings, sizes of elements may be exaggerated for clarity and convenience of explanation. The embodiments described below are merely exemplary, and various modifications may be possible from the embodiments.

In a layer structure described below, an expression “on” may include not only “immediately on in a contact manner” but also “on in a non-contact manner”. An expression used in the singular encompasses the expression of the plural, unless it has a clearly different meaning in the context. It will be further understood that the terms “comprises” and/or “comprising” used herein specify the presence of stated features or elements, but do not preclude the presence or addition of one or more other features or elements.

The use of “the” and other demonstratives similar thereto may correspond to both a singular form and a plural form. Unless the order of operations of a method according to the disclosure is explicitly mentioned or described otherwise, the operations may be performed in a proper order. The disclosure is not limited to the order the operations are mentioned.

The connecting lines, or connectors shown in the various figures presented are intended to represent functional relationships and/or physical or logical couplings between the various elements. It should be noted that many alternative or additional functional relationships, physical connections or logical connections may be present in a practical device.

The use of any and all examples, or language provided herein, is intended merely to better illuminate the disclosure and does not pose a limitation on the scope of the disclosure unless otherwise claimed.

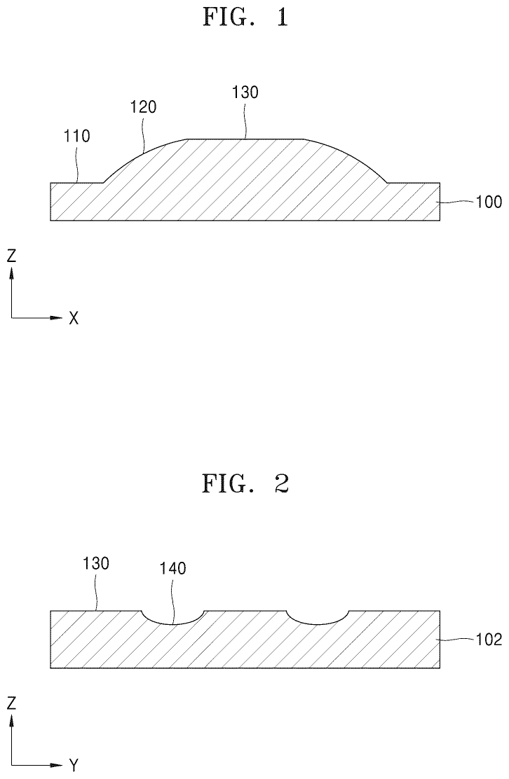

FIGS. 1 and 2 are cross-sectional views illustrating an optical waveguide 100 according to one or more embodiments. FIG. 1 is a cross-sectional view illustrating an xz plane of the optical waveguide 100, and FIG. 2 is a cross-sectional view illustrating an yz plane of the optical waveguide 100.

Referring to FIG. 1, the optical waveguide 100 may include a first face 110, a third face 130, and a second face 120 connecting the first face 110 to the third face 130.

An optical signal may be incident on the optical waveguide 100 through a first end of the optical waveguide 100, and may be emitted to the outside through a second end of the optical waveguide 100. The optical waveguide 100 may be connected to a light source that emits an optical signal and may guide the optical signal emitted from the light source in a certain direction.

The optical waveguide 100 may extend in a first direction (y-axis direction), and may have a constant width in a second direction (x-axis direction) perpendicular to the first direction (y-axis direction). The x-axis direction and the y-axis direction may be parallel to an upper surface of the optical waveguide 100. Accordingly, the optical waveguide 100 may guide the optical signal emitted from the light source in the first direction (y-axis direction).

The optical waveguide 100 may include, for example, a rib waveguide having a pattern partially etched in a thickness direction, but is not limited thereto and may have various shapes.

The optical waveguide 100 may include silicon. The optical waveguide 100 may include, for example, polysilicon or single crystalline silicon.

The first face 110 may be referred to as a bottom face. The first face 110 may be formed by etching a part of the third face 130. The first face 110 may be spaced apart from the third face 130 in a z-axis direction that is perpendicular to an upper surface of the optical waveguide 100, and perpendicular to the x-axis direction and the y-axis direction.

The second face 120 may be referred to as a side face. The second face 120 may be formed by etching a part of the third face 130. The second face 120 may have a curved shape. The second face 120 may have various shapes by adjusting the shape and thickness of a diffusion barrier layer used in a process of manufacturing the optical waveguide 100.

A part of the third face 130 may be oxidized to form the first face 110 and the second face 120. The first face 110 and the second face 120 may have the same surface roughness. The first face 110 and the second face 120 may have a relatively low surface roughness.

The third face 130 may be referred to as a top face. The third face 130 may form the uppermost face of the optical waveguide 100 in the z-axis direction. The third face 130 may be spaced apart from the first face 110 in the z-axis direction. The third face 130 may be formed with a step difference in the z-axis direction from the first face 110. For example, a level of the third face 130 may be different from a level of the first face 110 in the z-axis direction. The third face 130 may be substantially parallel to the first face 110.

Referring to FIG. 2, the third face 130 of the optical waveguide 100 may include a plurality of grooves 140.

The groove 140 may be referred to as a grating mirror. The groove 140 may reflect light. As the optical waveguide 100 includes the groove 140, the optical waveguide 100 has a constant width in areas that do not include the groove 140, and the width of the optical waveguide 100 may become narrower in areas including the groove 140. For example, a refractive index of the waveguide 100 decreases in the areas including the groove 140, which causes reflection of light.

The groove 140 may have a curved shape. The groove 140 may have various depths according to applications. The depth of the groove 140 may be, for example, about 1 nm or more to about 100 nm or less. The depth of the groove 140 may be, for example, about 3 nm or more to about 15 nm or less.

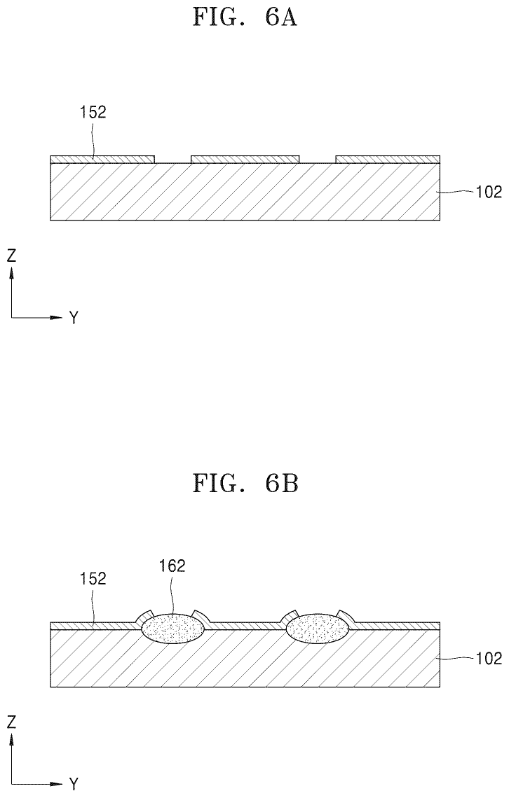

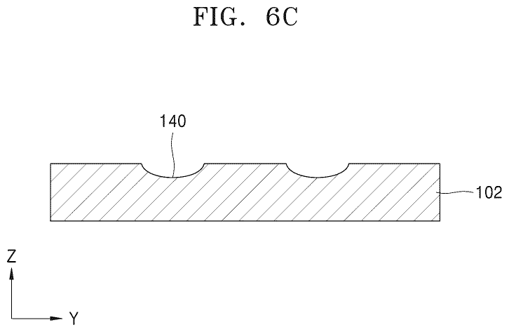

The groove 140 may be formed by oxidizing the optical waveguide 100. A method of forming the groove 140 will be described below with reference to FIGS. 6A to 6C.

When the surface roughness of each face included in the optical waveguide 100 is relatively high, energy loss is relatively large due to scattering of light. The optical waveguide 100 according to one or more embodiments may etch a face by using an oxidation process, thereby reducing the surface roughness of the etched face, and may reduce scattering of light by reducing the surface roughness of the etched face, thereby reducing energy loss of the optical waveguide 100.

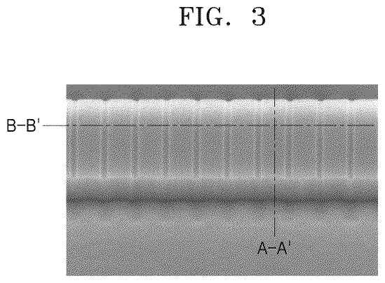

FIG. 3 is a scanning electron microscope image of an optical waveguide according to one or more embodiments.

Referring to FIG. 3, it may be seen that a plurality of mirrors are provided on a lip-type optical waveguide. Along the line A-A′, the mirrors are provided above, and the optical waveguide is provided below. A plurality of grooves across the line B-B′ represent the plurality of grooves 140 of FIG. 2 described with reference to FIG. 2.

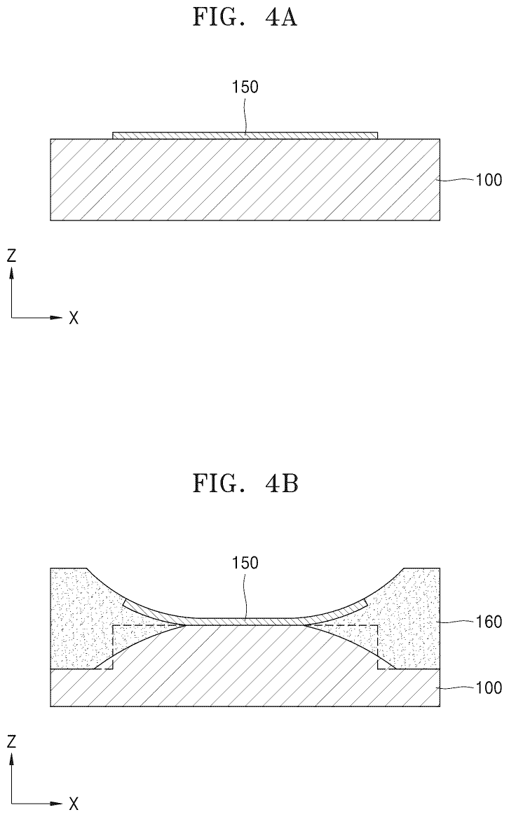

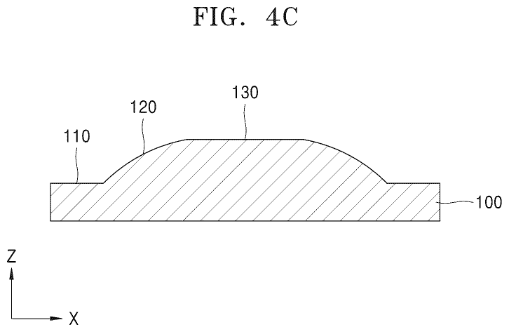

FIGS. 4A, 4B, and 4C illustrate the method of manufacturing the optical waveguide 100 according to one or more embodiments taken along line A-A′ of FIG. 3.

Referring to FIG. 4A, a diffusion barrier layer 150 may be provided on the optical waveguide 100. The diffusion barrier layer 150 may prevent the optical waveguide 100 from being oxidized. The diffusion barrier layer 150 may include, for example, nitride. The diffusion barrier layer 150 may include, for example, silicon nitride. The diffusion barrier layer 150 may include, for example, Si₃N₄. The shape of the optical waveguide 100 may be adjusted by adjusting the shape and thickness of the diffusion barrier layer 150.

Referring to FIG. 4B, the optical waveguide 100 may be oxidized. A part of the optical waveguide 100 may be oxidized to form an oxide layer 160. Because oxidation occurs in an isotropic direction, the oxide layer 160 may push up the diffusion barrier layer 150, and a part of the diffusion barrier layer 150 may be bent due to the oxide layer 160. Due to the oxide layer 160, the optical waveguide 100 may have a curved edge region.

Referring to FIG. 4C, the diffusion barrier layer 150 and the oxide layer 160 may be removed. The optical waveguide 100 may be etched through oxidation to include a plurality of faces. The optical waveguide 100 may include the first face 110, the second face 120, and the third face 130. Through oxidation that occurs in the isotropic direction, the surface roughness of an etched face may be reduced.

The second face 120 may be connected to the first face 110. The third face 130 may be connected to the first face 110 by the second face 120. The third face 130 may be formed with a step difference from the first face 110. The third face 130 may form the uppermost face of the optical waveguide 100 in the z-axis direction.

The method of manufacturing the optical waveguide according to one or more embodiments may reduce the surface roughness of the etch face by oxidizing the optical waveguide 100, and may reduce the energy loss of the optical waveguide 100 by reducing the surface roughness of the etch face.

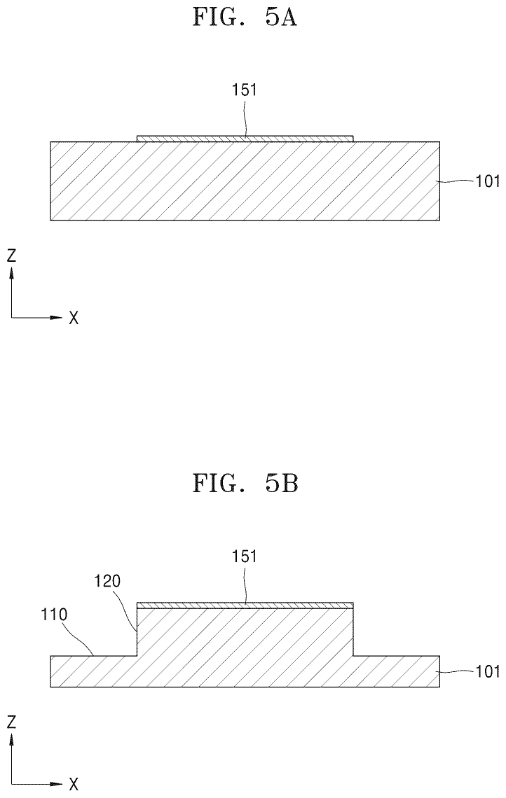

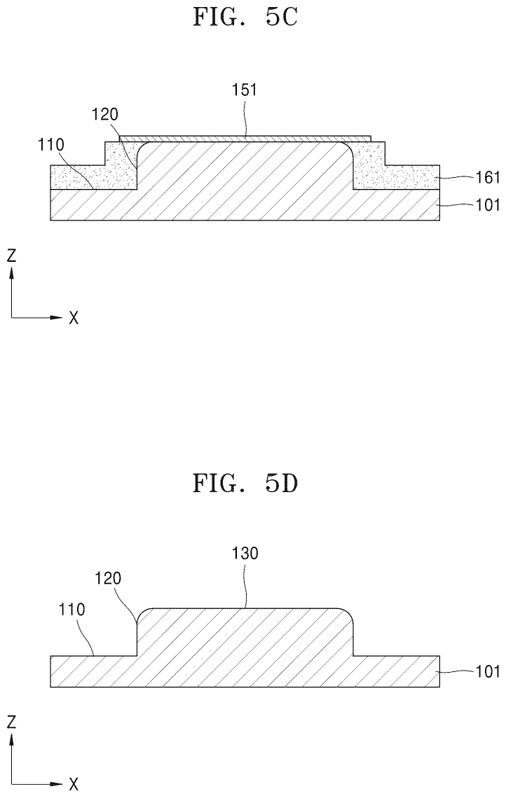

FIGS. 5A, 5B, 5C, and 5D illustrate the method of manufacturing the optical waveguide 101 taken along line A-A′ of FIG. 3.

Referring to FIG. 5A, a diffusion barrier layer 151 may be provided on the optical waveguide 101. The diffusion barrier layer 151 may include, for example, nitride. The diffusion barrier layer 151 may include, for example, silicon nitride. The diffusion barrier layer 151 may include, for example, Si₃N₄. The shape of the optical waveguide 101 may be adjusted by adjusting the shape and thickness of the diffusion barrier layer 151.

Referring to FIG. 5B, a part of each of the optical waveguide 101 and the diffusion barrier layer 151 may be etched. Etching may be, for example, dry etching. The part of the optical waveguide 101 may be etched to form the first face 110 and the second face 120.

Referring to FIG. 5C, the optical waveguide 101 may be oxidized. A part of the optical waveguide 101 may be oxidized to form an oxide layer 161. Due to the oxide layer 161, the optical waveguide 101 may have a curved edge region. Due to the oxide layer 161, the second face 120 may be etched to have a curved shape.

Referring to FIG. 5D, the diffusion barrier layer 151 and the oxide layer 161 may be removed. The optical waveguide 101 may be oxidized to include a plurality of faces. The optical waveguide 101 may include the first face 110, the third face 130, and the second face 120 connecting the first face 110 to the third face 130.

The method of manufacturing the optical waveguide 101 according to one or more embodiments may form a desired shape by etching the optical waveguide 101 and then oxidizing the optical waveguide 101, thereby reducing the surface roughness of the etched face.

FIGS. 6A, 6B, and 6C illustrate the method of manufacturing the optical waveguide 102 according to one or more embodiments taken along line B-B′ of FIG. 3.

Referring to FIG. 6A, a diffusion barrier layer 152 may be provided on the optical waveguide 102. A plurality of diffusion barrier layers 152 may be provided. The diffusion barrier layer 152 may include, for example, an oxide. The diffusion barrier layer 152 may include, for example, silicon oxide. The diffusion barrier layer 152 may include, for example, SiO₂. The diffusion barrier layer 152 may include, for example, silicon nitride. The diffusion barrier layer 152 may include, for example, Si₃N₄. The shape of the optical waveguide 102 may be adjusted by adjusting the shape and thickness of the diffusion barrier layer 152.

The diffusion barrier layer 152 may be provided on and cover a part of the optical waveguide 102 without covering the entirety of the optical waveguide 102. A part of the optical waveguide 102 on which the diffusion barrier layer 152 is not provided and exposed may be oxidized thereafter.

Referring to FIG. 6B, the optical waveguide 102 may be oxidized. The part of the optical waveguide 102 may be oxidized to form a plurality of oxide layers 162. A part of the diffusion barrier layer 152 may be bent due to the oxide layer 162. The groove 140 of FIG. 6C may be formed in the optical waveguide 102 due to the oxide layer 162.

Referring to FIG. 6C, the diffusion barrier layer 152 and the oxide layer 162 may be removed. Due to the oxide layer 162, the optical waveguide 102 may include the plurality of grooves 140. The groove 140 may have a curved shape. The groove 140 may have various depths according to applications. The depth of the groove 140 may be, for example, about 1 nm or more to about 100 nm or less. The depth of the groove 140 may be, for example, about 3 nm or more to about 15 nm or less.

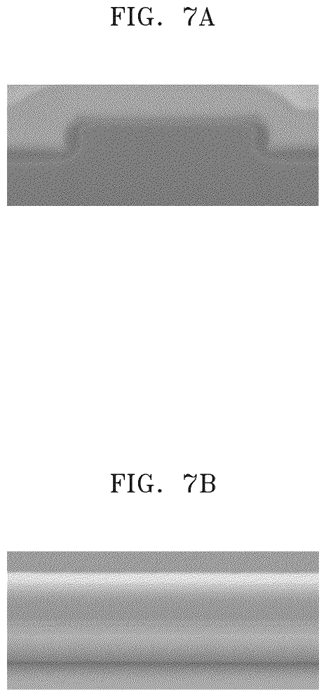

FIGS. 7A and 7B are scanning electron microscope images of an optical waveguide according to one or more embodiments.

FIG. 7A illustrates the optical waveguide viewed in the same direction as FIG. 1, and FIG. 7B illustrates the optical waveguide viewed in the same direction as FIG. 2.

FIG. 7A illustrates that an edge region of the optical waveguide has a curved shape, and FIG. 7B illustrates that a surface next to the optical waveguide is provided. Accordingly, it may be confirmed that the surface roughness of an etched face may be reduced by oxidizing the optical waveguide. Energy loss of the optical waveguide may be reduced by reducing the surface roughness of the etched face.

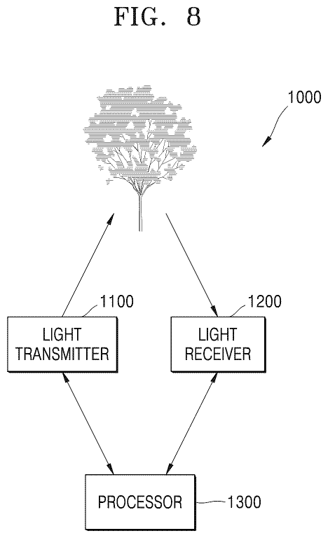

FIG. 8 is a view briefly illustrating a light detection and ranging (LiDAR) device 1000 according to one or more embodiments.

Referring to FIG. 8, the LiDAR device 1000 may include an optical transmitter 1100 irradiating light onto a target, an optical receiver 1200 receiving light reflected from the target, and a processor 1300 performing operations to obtain information about the target from the light received by the optical receiver 1200. The optical transmitter 1100 may include a light source generating light and a steering unit steering the light output from the light source toward the target. The LiDAR device 1000 may include an optical waveguide providing a path through which light travels within the optical transmitter 1100 or the optical receiver 1200. The LiDAR device 1000 may include an optical waveguide providing an optical connection between the light source and the steering unit. The optical waveguide may be the same as the optical waveguide described in FIG. 1. The optical transmitter 1100, the optical receiver 1200, and the processor 1300 may be implemented as separate devices or as a single device.

The light source may be a wavelength-variable light source capable of adjusting the wavelength of discharged light. A plurality of laser beams may be emitted from the light source, and among the plurality of laser beams, laser beams having mutual coherence may be incident on the steering unit. The light source may generate and output light in a plurality of different wavelength bands. In addition, the light source may generate and output pulsed light or continuous light.

The light source may include, for example, a laser diode (LD), an edge-emitting laser, a vertical-cavity surface-emitting laser (VCSEL), a distributed feedback laser, a light-emitting diode (LED), a super luminescent diode (SLD), etc.

The steering unit may illuminate the target by changing the propagation direction of light emitted from the light source, and may include an optical phase array device capable of adjusting the direction of light without mechanical movement. The steering unit may transmit amplified light toward a local area ahead by a one-dimensional (1D) scanning method or a two-dimensional (2D) scanning method. The steering unit may steer narrowly condensed light, either sequentially or non-sequentially, to 1D areas or 2D areas ahead at regular time intervals. For example, the steering unit may be configured to output laser light, either from bottom to top or top to bottom, with respect to the 1D areas ahead. In addition, the steering unit may be configured to output laser light, either from left to right or right to left, with respect to the 2D areas ahead.

The optical receiver 1200 may receive light reflected from the target and generate an electrical signal based on the received light. The optical receiver 1200 may include an array of optical detection elements. The optical receiver 1200 may further include a processing circuit.

The processor 1300 may perform operations to obtain the information about the target from the light received by the optical receiver 1200. In addition, the processor 1300 may comprehensively manage processing and control operations of the LiDAR device 1000. The processor 1300 may obtain and process the information about the target. For example, the processor 1300 may obtain and process 2D image information or three-dimensional (3D) image information. The processor 1300 may comprehensively control driving of the optical transmitter 1100 or operation of the optical receiver 1200. For example, the processor 1300 may control electrical signals applied to the optical phased array device of the steering unit. The processor 1300 may also analyze a distance between the target and the LiDAR device 1000 and a shape of the target, through numerical information provided by the optical receiver 1200.

3D images obtained by the processor 1300 may be transmitted to other units for utilization. For example, such information may be transmitted the processor 1300 of an autonomous driving device such as an autonomous vehicle or an autonomous drone that employs the LiDAR device 1000. In addition, such information may be utilized in smartphones, mobile phones, personal digital assistants (PDAs), laptops, personal computers (PCs), wearable devices, and other mobile or non-mobile computing devices.

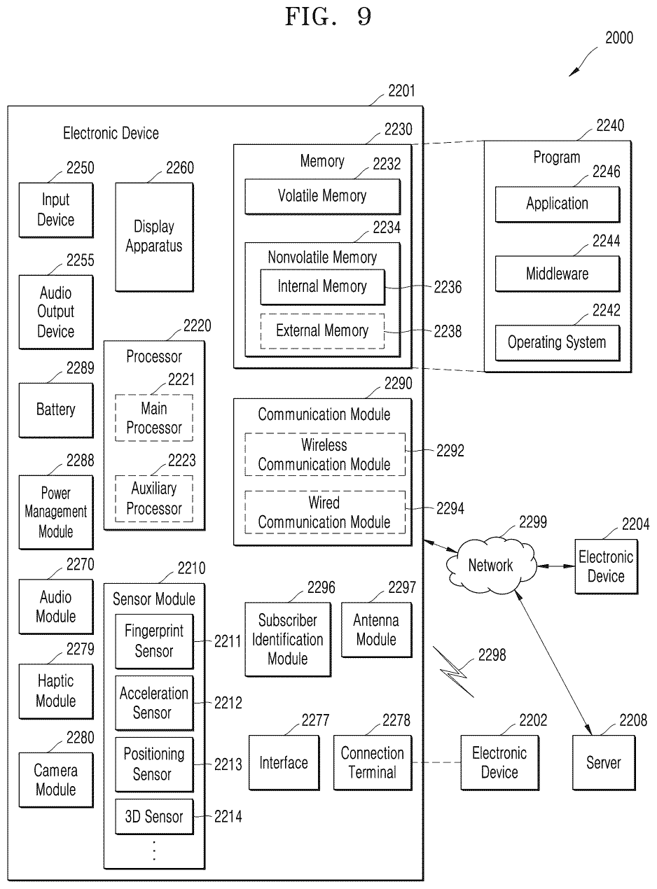

FIG. 9 is a block diagram of an electronic device including the LiDAR device 1000 according to one or more embodiments.

Referring to FIG. 9, in a network environment 2000, the electronic device 2201 may communicate with another electronic device 2202 through a first network 2298 (a short-range wireless communication network, etc.), or communicate with another electronic device 2204 and/or a server 2208 through a second network 2299 (a remote wireless communication network). The electronic device 2201 may communicate with the electronic device 2204 through the server 2208. The electronic device 2201 may include a processor 2220, a memory 2230, an input device 2250, an audio output device 2255, a display apparatus 2260, an audio module 2270, a sensor module 2210, and an interface 2277, a haptic module 2279, a camera module 2280, a power management module 2288, a battery 2289, a communication module 2290, a subscriber identification module 2296, and/or an antenna module 2297. In the electronic device 2201, some (the display apparatus 2260, etc.) of these components may be omitted or other components may be added. Some of these components may be implemented as one integrated circuit. For example, a fingerprint sensor 2211 or an iris sensor, an illuminance sensor, etc. of the sensor module 2210 may be implemented by being embedded in the display apparatus 2260 (display, etc.)

The processor 2220 may execute software (the program 2240, etc.) to control one or a plurality of other components (hardware components, software components, etc.) of the electronic device 2201 connected to the processor 2220, and perform various data processing or operations. As part of data processing or operation, the processor 2220 may load commands and/or data received from other components (the sensor module 2210, the communication module 2290, etc.) into a volatile memory 2232, process commands and/or data stored in the volatile memory 2232, and store result data in a nonvolatile memory 2234. The processor 2220 may include a main processor 2221 (a central processing unit, an application processor, etc.) and a secondary processor 2223 (a graphics processing unit, an image signal processor, a sensor hub processor, a communication processor, etc.) that may be operated independently or together. The secondary processor 2223 may use less power than the main processor 2221 and may perform specialized functions.

The secondary processor 2223 may control functions and/or states related to some of the components of the electronic device 2202 (the display apparatus 2260, the sensor module 2210, the communication module 2290, etc.) instead of the main processor 2221 while the main processor 2221 is in an inactive state (sleep state), or with the main processor 2221 while the main processor 2221 is in an active state (application execution state). The secondary processor 2223 (an image signal processor, a communication processor, etc.) may be implemented as part of other functionally related components (the camera module 2280, the communication module 2290, etc.)

The memory 2230 may store various data required by components of the electronic device 2201 (the processor 2220, the sensor module 2210, etc.) The data may include, for example, software (the program 2240, etc.) and input data and/or output data for commands related thereto. The memory 2230 may include the volatile memory 2232 and/or the nonvolatile memory 2234.

The program 2240 may be stored as software in the memory 2230 and may include an operating system 2242, a middleware 2244, and/or an application 2246.

The input device 2250 may receive commands and/or data to be used for components (the processor 2220, etc.) of the electronic device 2201 from outside (a user, etc.) of the electronic device 2201. The input device 2250 may include a microphone, a mouse, a keyboard, and/or a digital pen (a stylus pen, etc.)

The audio output device 2255 may output an audio signal to the outside of the electronic device 2201. The audio output device 2255 may include a speaker and/or a receiver. The speaker may be used for general purposes such as multimedia playback or recording playback, and the receiver may be used to receive incoming calls. The receiver may be combined as a part of the speaker or may be implemented as an independent separate device.

The display apparatus 2260 may visually provide information to the outside of the electronic device 2201. The display apparatus 2260 may include the display, a hologram device, or a projector and a control circuit for controlling the device. The display apparatus 2260 may include a touch circuit set to sense a touch, and/or a sensor circuit (a pressure sensor, etc.) set to measure the strength of a force generated by the touch.

The audio module 2270 may convert sound into an electrical signal, or conversely, may convert an electrical signal into sound. The audio module 2270 may obtain sound through the input device 2250 or output sound through speakers and/or headphones of the audio output device 2255, and/or another electronic device (the electronic device 2202) directly or wirelessly connected to electronic device 2201.

The sensor module 2210 may detect an operating state (power, temperature, etc.) of the electronic device 2201 or an external environmental state (a user state, etc.), and generate an electrical signal and/or data value corresponding to the detected state. The sensor module 2210 may include the fingerprint sensor 2211, an acceleration sensor 2212, a positioning sensor 2213, a 3D sensor 2214, etc. and may further include an iris sensor, a gyro sensor, a barometric pressure sensor, a magnetic sensor, a grip sensor, a proximity sensor, a color sensor, an infrared (IR) sensor, a biometric sensor, a temperature sensor, a humidity sensor, and/or an illuminance sensor.

The 3D sensor 2214 senses the shape and movement of a subject by irradiating certain light to the subject and analyzing the light reflected from the subject, and the LiDAR device 1000 described with reference to FIG. 8 may be used.

The interface 2277 may support one or more specified protocols that may be used for the electronic device 2201 to connect directly or wirelessly with another electronic device (the electronic device 2202, etc.) The interface 2277 may include a High Definition Multimedia Interface (HDMI), a Universal Serial Bus (USB) interface, an SD card interface, and/or an audio interface.

The connection terminal 2278 may include a connector through which the electronic device 2201 may be physically connected to another electronic device (the electronic device 2202, etc.) The connection terminal 2278 may include an HDMI connector, a USB connector, an SD card connector, and/or an audio connector (a headphone connector, etc.)

The haptic module 2279 may convert an electrical signal into a mechanical stimulus (vibration, movement, etc.) or an electrical stimulus that a user may perceive through a tactile or motor sense. The haptic module 2279 may include a motor, a piezoelectric element, and/or an electrical stimulation device.

The camera module 2280 may capture a still image and a video. The camera module 2280 may include a lens assembly including one or more lenses, image sensors, image signal processors, and/or flashes. The lens assembly included in the camera module 2280 may collect light emitted from a subject that is a target of image capturing.

The power management module 2288 may manage power supplied to the electronic device 2201. The power management module 2288 may be implemented as a part of a power management integrated circuit (PMIC).

The battery 2289 may supply power to components of the electronic device 2201. The battery 2289 may include a non-rechargeable primary cell, a rechargeable secondary cell, and/or a fuel cell.

The communication module 2290 may support establishing a direct (wired) communication channel and/or a wireless communication channel, and performing communication through the established communication channel between the electronic device 2201 and other electronic devices (the electronic device 2202, the electronic device 2204, the server 2208, etc.) The communication module 2290 may include one or more communication processors that operate independently of the processor 2220 (an application processor, etc.) and support direct communication and/or wireless communication. The communication module 2290 may include a wireless communication module 2292 (a cellular communication module, a short-range wireless communication module, a Global Navigation Satellite System (GNSS) communication module, etc.) and/or a wired communication module 2294 (a local area network (LAN) communication module, a power line communication module, etc.) Among these communication modules, a corresponding communication module may communicate with other electronic devices through a first network 2298 (a short-range communication network such as Bluetooth, WiFi Direct, or Infrared Data Association (IrDA)) or a second network 2299 (a cellular network, the Internet, or a telecommunication network such as a computer network (LAN, WAN, etc.)) These various types of communication modules may be integrated into one component (a single chip, etc.), or may be implemented as a plurality of separate components (a plurality of chips). The wireless communication module 2292 may check and authenticate the electronic device 2201 in a communication network such as the first network 2298 and/or the second network 2299 using the subscriber information (international mobile subscriber identifier (IMSI), etc.) stored in the subscriber identification module 2296.

The antenna module 2297 may transmit signals and/or power to the outside (other electronic devices) or receive signals and/or power from the outside. The antenna may include a radiator made of a conductive pattern formed on a substrate (PCB, etc.) The antenna module 2297 may include one or a plurality of antennas. When the plurality of antennas are included, an antenna suitable for a communication method used in a communication network such as the first network 2298 and/or the second network 2299 may be selected from the plurality of antennas by the communication module 2290. Signals and/or power may be transmitted or received between the communication module 2290 and another electronic device through the selected antenna. In addition to the antenna, other components (radio frequency integrated circuit (RFIC), etc.) may be included as part of the antenna module 2297.

Some of the components are connected to each other and may exchange signals (commands, data, etc.) through communication method between peripheral devices (bus, General Purpose Input and Output (GPIO), Serial Peripheral Interface (SPI), Mobile Industry Processor Interface (MIPI), etc.)

The command or data may be transmitted or received between the electronic device 2201 and the external electronic device 2204 through the server 2108 connected to the second network 2299. The other electronic devices 2202 and 2204 may be the same or different types of devices as or from the electronic device 2201. All or some of the operations executed by the electronic device 2201 may be executed by one or more of the other electronic devices 2202, 2204, and 2208. For example, when the electronic device 2201 needs to perform a certain function or service, instead of executing the function or service itself, the electronic device 2201 may request one or more other electronic devices to perform the function or part or all of the service. One or more other electronic devices that receive the request may execute an additional function or service related to the request, and transmit a result of the execution to the electronic device 2201. To this end, cloud computing, distributed computing, and/or client-server computing technology may be used.

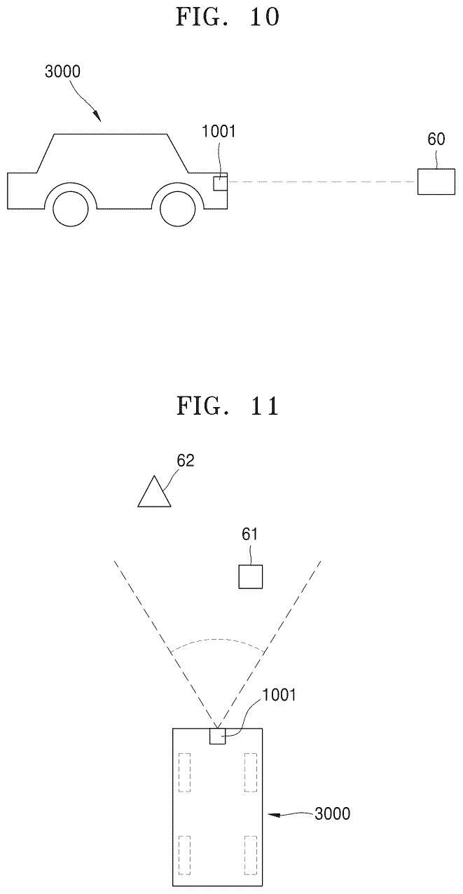

FIGS. 10 and 11 are a side view and a plan view illustrating an example in which a LiDAR device 1001 according to one or more embodiments is applied to a vehicle 3000.

Referring to FIG. 10, the LiDAR device 1001 may be applied to the vehicle 3000 to obtain information about a subject 60. The LiDAR device 1001 may be the LiDAR device 1000 described with reference to FIG. 8. The LiDAR device 1001 may use a time-of-flight (TOF) method to obtain information about the subject 60. The vehicle 3000 may be an autonomous vehicle. The vehicle 3000 may use the LiDAR device 1001 to detect objects or people such as the subject 60 in a direction of travel and measure the distance to the subject 60 by using information such as a time difference between signal transmission and signal detection. In addition, as shown in FIG. 11, information about a nearby subject 61 and a distant subject 62 that is farther away from the LiDAR device 1001 than the nearby subject 61, within a target field (TF) may be obtained.

FIGS. 10 and 11 illustrate an example in which the LiDAR device 1001 is applied to an automobile, but embodiments are not limited thereto. The LiDAR device 1001 may be applied to flying objects such as, for example, drones, mobile devices, small walking aids (e.g., bicycles, motorcycles, strollers, boards, etc.), robots, assistive devices for humans/animals (e.g., canes, helmets, accessories, clothing, watches, bags, etc.), Internet of things (IoT) devices/systems, security devices/systems, etc.

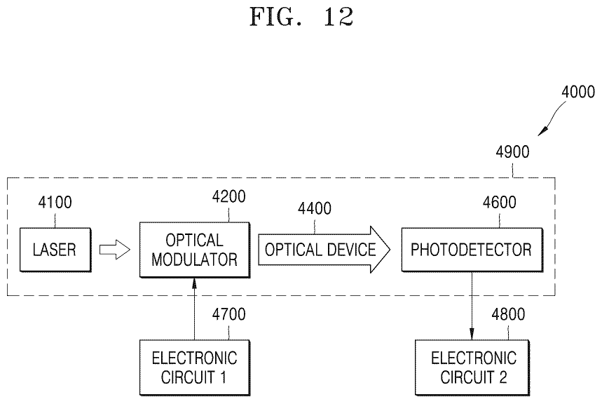

FIG. 12 is a block diagram illustrating a configuration of an optical integrated circuit 4000 according to one or more embodiments.

The optical integrated circuit 4000 may include a light source 4100, an optical device 4400 transmitting light from the light source 4100, and a photodetector 4600 converting the light transmitted through the optical device 4400 into an electrical signal. The optical device 4400 may include an optical waveguide of FIG. 1. In addition to a single waveguide, the optical device 4400 may include a splitter, a ring resonator, a grating coupler, etc.

Such a structure may be, for example, a part of a circuit constituting an optical transceiver. The optical integrated circuit 4000 may further include a light source 4100, an optical modulator 4200 disposed in the optical device 4400, an electronic circuit 4700 applying a modulation signal to the optical modulator 4200, and an electronic circuit 4800 to which the electrical signal converted by the photodetector 4600 is transferred.

The light source 4100, the optical modulator 4200, the optical device 4400, and the photodetector 4600 may be disposed on the same substrate 4900. The substrate 4900 may be a silicon substrate, and the photodetector 4600 may also be a photodiode using a silicon semiconductor.

According to one or more embodiments, the optical waveguide and the method of manufacturing the optical waveguide capable of reducing surface roughness through oxidation, and accordingly improving light transmission efficiency are provided.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope as defined by the following claims and their equivalents.

What is claimed is:

1. An optical waveguide comprising:
a first face;
a second face connected to the first face; and
a third face connected to the second face, a level of the third face being different from a level of the first face in a first direction, and the third face being an uppermost face in the first direction,
wherein a surface roughness of the first face is the same as a surface roughness of the second face.

2. The optical waveguide of claim 1, wherein the second face has a curved shape.

3. The optical waveguide of claim 1, wherein the third face comprises a groove.

4. The optical waveguide of claim 3, wherein a depth of the groove in the first direction is in a range of 1 nm to 100 nm.

5. The optical waveguide of claim 3, wherein a depth of the groove in the first direction is in a range of 3 nm to 15 nm.

6. The optical waveguide of claim 3, wherein the groove has a curved shape.

7. The optical waveguide of claim 1, wherein the optical waveguide comprises silicon.

8. The optical waveguide of claim 1, wherein the optical waveguide comprises a lip-type optical waveguide.

9. A method of manufacturing an optical waveguide, the method comprising:
forming a diffusion barrier layer on the optical waveguide;
forming a first face, a second face and a third face of the optical waveguide, by oxidizing the optical waveguide; and
removing the diffusion barrier layer,
wherein the second face is connected to the first face, the third face is connected to the second face, a level of the third face being different from a level of the first face in a first direction, and the third face being an uppermost face in the first direction.

10. The method of claim 9, wherein a surface roughness of the first face is the same as a surface roughness of the second face.

11. The method of claim 9, wherein the diffusion barrier layer comprises silicon nitride.

12. The method of claim 9, further comprising:
etching a part of the optical waveguide and a part of the diffusion barrier layer prior to the oxidizing of the optical waveguide.

13. The method of claim 12, wherein the etching comprises a dry etching process.

14. The method of claim 9, further comprising:
forming a groove in the third face.

15. The method of claim 14, wherein a depth of the groove in the first direction is in a range of 1 nm to 100 nm.

16. The method of claim 14, wherein a depth of the groove in the first direction is in a range of 3 nm to 15 nm.

17. The method of claim 14, wherein the groove has a curved shape.

18. The method of claim 9, wherein the second face has a curved shape.

19. An optical integrated circuit comprising:
a light source;
an optical waveguide configured to transmit light from the light source; and
a photodetector configured to convert light transmitted through the optical waveguide into an electrical signal,
wherein the optical waveguide comprises:
a first face;
a second face connected to the first face; and
a third face connected to the second face, a level of the third face being different from a level of the first face in a first direction, and the third face being an uppermost face in the first direction,
wherein a surface roughness of the first face the same as a surface roughness of the second face.

20. The optical integrated circuit of claim 19, wherein the second face has a curved shape.
